(19) United States
(12) Patent Application Publication
(10) Pub. No.: US 2017/0076336 A1
(43) Pub. Date: Mar. 16, 2017

(54) METHODS AND SYSTEMS FOR WIDGET OPTIMIZER

(71) Applicants: Chris Maynard, Sarasota, FL (US); Aziz Hussain, Sarasota, FL (US); John Daniel Lemp, Sarasota, FL (US)

(72) Inventors: Chris Maynard, Sarasota, FL (US); Aziz Hussain, Sarasota, FL (US); John Daniel Lemp, Sarasota, FL (US)

(73) Assignee: RevContent, LLC, Sarasota, FL (US)

(21) Appl. No.: 15/263,040

(22) Filed: Sep. 12, 2016

Related U.S. Application Data
(60) Provisional application No. 62/217,378, filed on Sep. 11, 2015.

(51) Int. Cl. G06Q 30/02; H04L 29/06; G06F 17/30

(52) U.S. Cl. CPC G06Q 30/0276; G06Q 30/0277; G06F 17/3089; G06F 17/30887; H04L 63/10

(57) ABSTRACT

Aspects of the present disclosure are presented for advertisers in e-marketing campaigns to specify with greater granularity and control where and on what websites their advertisements may be placed on publisher websites, through a third party advertising platform. The advertisers utilizing this functionality may be able to improve their advertising effectiveness by having more control, such as eliminating placement of ads that have been shown to generate poor marketing results, or increasing placement onto websites that have been shown to have effective marketing results. The third party advertising platform may place the control directly with the advertiser, allowing the advertiser to specify which websites and where in the websites the widgets should be placed without needing to coordinate with the third party advertising company.

### CROSS REFERENCE TO RELATED APPLICATIONS

This application claims the benefits of U.S. Provisional Application 62/217,378, filed Sep. 11, 2015, and titled, “METHODS AND SYSTEMS FOR WIDGET OPTIMIZER,” the disclosure of which is incorporated herein by reference in its entirety and for all purposes.

### TECHNICAL FIELD

The subject matter disclosed herein generally relates to processing data. In some embodiments, the present disclosures relate to methods and apparatuses for a widget optimizer in website advertising.

### BACKGROUND

In e-marketing and e-commerce, a third party advertising company may assist advertisers in conducting advertising campaigns in publisher digital media. The advertising company may coordinate with advertisers and publishers (e.g., websites) by accepting advertisements and working with publishers to display the advertisements somewhere within the website. An advertising program, called a widget, is placed in the website at a particular location within the website, which contains at least the advertisement and a link that leads out of the publisher website and into a website of the advertiser. Conventionally, the third party advertising company can allow a limited degree of maneuverability on the part of the advertisers to specify where or on what websites their advertisements should be displayed. Conventionally, the advertiser must work with the third party advertising company, who then manually reconfigures one or more widgets to accommodate the desires of the advertiser. It is desirable to improve the functionality in advertising campaigns and to allow advertisers more control in how to customize their campaigns.

### BRIEF SUMMARY

Aspects of the present disclosure are presented for a third party advertising platform in e-commerce and e-marketing to enable an advertiser to better customize where advertisements are to appear on a publisher's website or other digital media.

In some embodiments, a method for conducting advertising in digital media is presented. The method may include: receiving, by a processor, an input by an advertiser to generate an e-marketing advertising campaign; receiving, by the processor, information associated with one or more advertisements to be displayed in one or more publisher's websites; generating, by the processor, one or more widgets comprising an image associated with an advertisement of the advertiser and a URL associated with a website of the advertiser, the widget configured to be embedded into the one or more publisher's websites and to display the image associated with the advertisement on the one or more publisher's websites; receiving from the advertiser an input to operate a widget optimizer function that enables the advertiser to directly control at least one characteristic defining how the widget is to be displayed in the one or more publisher's websites; and causing display of the image of the widget in the one or more publisher's websites in accordance with how the advertiser has defined the widget to be displayed.

In some embodiments, the method further includes receiving an input to enable a URL passback function to be applied to the widget, the URL passback function configured to track an ID tag associated with the widget.

In some embodiments of the method, the at least one characteristic comprises a location in a publisher's website.

In some embodiments of the method, the at least one characteristic comprises a whitelist enablement feature to require that the widget be displayed in a whitelisted website.

In some embodiments of the method, the at least one characteristic comprises a blacklist feature to require that the widget be prohibited from being displayed in a blacklisted website. In some embodiments, receiving the input to generate the e-marketing campaign comprises receiving an input to whitelist a category of websites to be targeted in the e-marketing campaign. In some embodiments, the blacklisted website that the widget is prohibited from being displayed in is a website among the whitelisted category of websites to be targeted in the e-marketing campaign.

In some embodiments, a system comprising a memory and a processor is presented. The processor of the system may be configured to: receive an input by an advertiser to generate an e-marketing advertising campaign; receive information associated with one or more advertisements to be displayed in one or more publisher's websites; generate one or more widgets comprising an image associated with an advertisement of the advertiser and a URL associated with a website of the advertiser, the widget configured to be embedded into the one or more publisher's websites and to display the image associated with the advertisement on the one or more publisher's websites; receive from the advertiser an input to operate a widget optimizer function that enables the advertiser to directly control at least one characteristic defining how the widget is to be displayed in the one or more publisher's websites; and cause display of the image of the widget in the one or more publisher's websites in accordance with how the advertiser has defined the widget to be displayed.

In some embodiments, a non transitory computer readable medium is presented comprising instructions that, when interpreted by a processor, cause a machine to perform operations comprising: receiving an input by an advertiser to generate an e-marketing advertising campaign; receiving information associated with one or more advertisements to be displayed in one or more publisher's websites; generating one or more widgets comprising an image associated with an advertisement of the advertiser and a URL associated with a website of the advertiser, the widget configured to be embedded into the one or more publisher's websites and to display the image associated with the advertisement on the one or more publisher's websites; receiving from the advertiser an input to operate a widget optimizer function that enables the advertiser to directly control at least one characteristic defining how the widget is to be displayed in the one or more publisher's websites; and causing display of the image of the widget in the one or more publisher's websites in accordance with how the advertiser has defined the widget to be displayed.

### BRIEF DESCRIPTION OF THE DRAWINGS

Some embodiments are illustrated by way of example and not limitation in the figures of the accompanying drawings.

FIG. 1 is a network diagram illustrating an example network environment suitable for performing aspects of the present disclosure, according to some embodiments.

FIG. 2 provides an example flowchart facilitating advertisement placement on publisher websites through the third party advertising platform, by allowing the advertiser user to create an advertising campaign, according to some embodiments.

FIG. 3 provides an example illustration for prompting a user, by the advertising platform, to create a campaign boost, according to some embodiments.

FIG. 4 shows an example of whitelisting at the topic targeting level for a campaign, according to some embodiments.

FIG. 5 shows a resulting status screen for any and all criteria that have been specifically targeted from the initial targeting menu shown in FIG. 3, according to some embodiments.

FIG. 6 shows an example display of how the widget optimizer of the present disclosure may be reached and utilized within the campaign creation functionality, according to some embodiments.

FIG. 7A shows an example display interface for utilizing the widget ID URL Passback functionality, according to some embodiments.

FIG. 7B shows an example display interface for utilizing the widget optimizer whitelist and blacklist functionality, according to some embodiments.

FIG. 7C shows an example user interface for processing the whitelist or blacklisted widget IDs, according to some embodiments.

FIG. 8 shows a flowchart for example code for enabling the passback functionality of the widget optimizer, according to some embodiments.

FIG. 9 shows a flowchart for example code execution for incorporating the whitelisted or blacklisted websites into an advertising campaign, according to some embodiments.

FIG. 10 shows a flowchart for example code for adding whitelisted websites to an advertiser's list, according to some embodiments.

FIG. 11 shows a flowchart for example code for removing blacklisted websites from an advertiser user's list, according to some embodiments.

FIG. 12 shows a flowchart for example code for applying the whitelisted and blacklisted settings in a filtering process, according to some embodiments.

FIG. 13 is a block diagram illustrating components of a machine, according to some example embodiments, able to read instructions from a machine-readable medium and perform any one or more of the methodologies discussed herein.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. As used in this specification and the appended claims, the singular forms “a,” “an,” and “the” include plural referents unless the context clearly indicates otherwise.

Systems, methods, and apparatuses are presented for a third party advertising platform in e-commerce to enable an advertiser to customize where advertisements are to appear on a publisher's website in e-commerce and e-marketing. Typically, a third party advertising company coordinates with advertisers and publishers (e.g., websites) by accepting advertisements and working with publishers to display the advertisements somewhere within the website. An advertising program, called a widget, is placed in the website at a particular location within the website, which contains at least the advertisement and a link that leads out of the publisher website and into a website of the advertiser. Conventionally, the third party advertising company can allow a limited degree of maneuverability on the part of the advertisers to specify where or on what websites their advertisements should be displayed. For example, conventionally, the advertisers may specify that their ads should be displayed on websites having a general type of subject matter, such as blogs related to food or websites related to travel. In other cases, conventionally, the advertisers may be able to place bids to compete for where they would like their advertisements to be placed. Conventionally, the advertiser must work with the third party advertising company, who then reconfigures one or more widgets to accommodate the desires of the advertiser.

Aspects of the present disclosure allow for advertisers to specify with greater granularity and control where and on what websites their advertisements may be placed on publisher websites, through the third party advertising platform. The advertisers utilizing this functionality may be able to improve their advertising effectiveness by having more control, such as eliminating placement of ads that have been shown to generate poor marketing results, or increasing placement to websites that have been shown to have effective marketing results. The third party advertising platform may place the control directly with the advertiser, allowing the advertiser to specify which websites and where in the websites the widgets should be placed without needing to coordinate with the third party advertising company. With the additional functionality provided herein, advertisers may be more inclined to utilize the third party advertising platform having these features compared to a competitor platform that does not. In addition, the functionality presented herein may allow the advertisers to more efficiently utilize their advertising resources by, for example, if a bidding mechanism for ad placement is in place, adjust their bids for particular positions within a website based on marketing feedback showing which ad placements are more effective than others.

In some embodiments, a user of the third party advertising platform of the present disclosures may possess the ability to white-list or black-list particular publishers (e.g., websites), for positively enabling websites that have been shown to generate desirable ad revenue and for eliminating websites that have been shown to not generate desirable ad revenue, respectively.

In some embodiments, a passback functionality is provided to allow the advertiser to track data about the ad traffic generated by the placement of the ad. For example, the passback functionality may cause a pointer variable or tag, such as a widget ID, to be populated or enabled upon a user clicking the ad. Using additional analytics software, the advertiser may then gather marketing data over time and may be able to organize the data based on the pointer variable or tag provided by the passback functionality.

In some embodiments, the user of the third party advertising platform may create more intricate campaign targeting by whitelisting and/or blacklisting publishers and other websites at a first level of specificity, while whitelisting and/or blacklisting particular placements of advertisements at a second level of specificity that is more granular than the first level of specificity. For example, the user may create a campaign that whitelists a particular publisher, but within that particular whitelisted publisher, blacklists certain websites or particular placements within one or more websites using the widget optimizer of the present disclosure. As another example, the user may create a campaign that blacklists a number of publishers, and within the publishers not blacklisted, whitelists particular placements within non-blacklisted websites using the widget optimizer of the present disclosure.

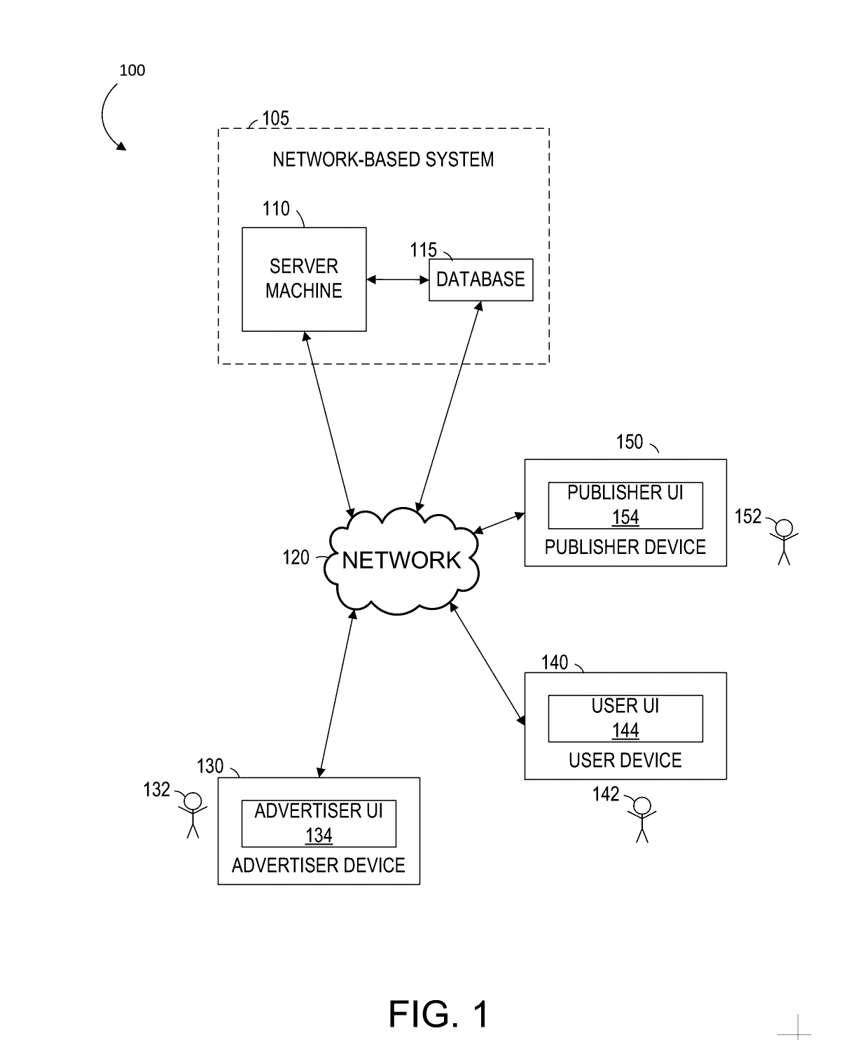

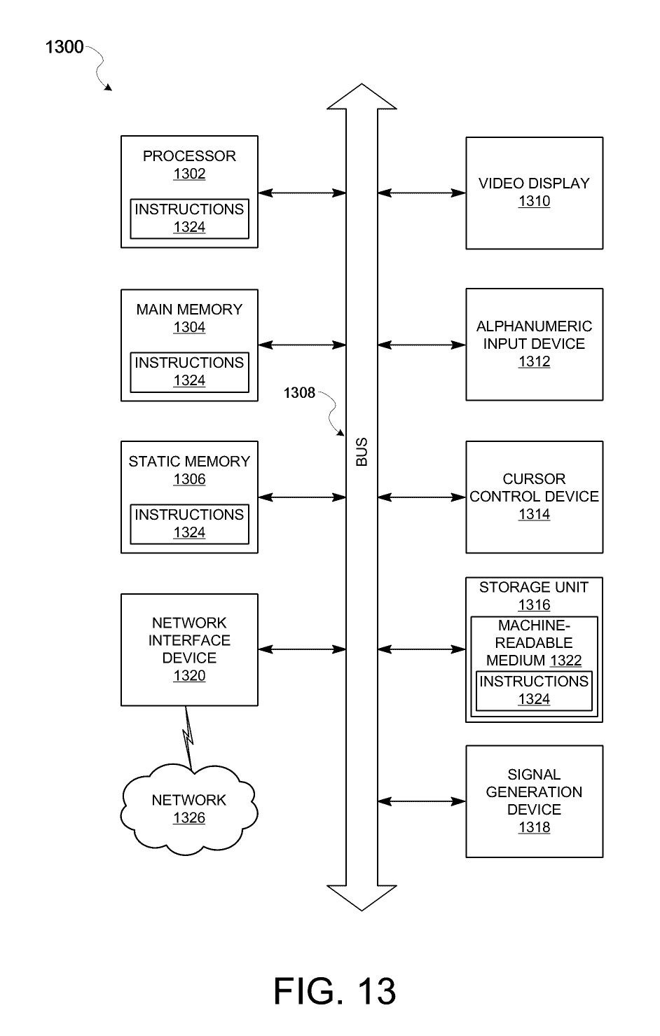

Referring to FIG. 1, a network diagram illustrating an example network environment 100 suitable for performing aspects of the present disclosure is shown, according to some embodiments. The example network environment 100 includes a server machine 110 and a database 115 of a network-based system 105 of a third-party advertising platform, an advertiser device 130 for an advertiser user 132, a user device 140 for a user 142 who accesses websites on the Internet, and a publisher device 150 for a publisher user 152 who publishes websites, all communicatively coupled to each other via a network 120. The server machine 110 may be implemented by a physical server machine, a virtual server machine, or a combination of the two. may form all or part of a network-based system 105 (e.g., a cloud-based server system configured to provide one or more services to the advertiser device 130, user device 140 and publisher device 140). The network-based system 105 may be configured to facilitate advertisement placements by advertisers, such as advertiser user 132, onto websites of publishers, such as publisher user 152. The server machine 110, the advertiser device 130, the user device 140, and the publisher device 150 may each be implemented in a computer system, in whole or in part, as described below with respect to FIG. 13.

Also shown in FIG. 1 are the advertiser user 132, the website user 142, and the publisher user 152. One or more of the users 132, 142, and 152 may be a human user, a machine user (e.g., a computer configured by a software program to interact with the advertiser device 130), or any suitable combination thereof (e.g., a human assisted by a machine or a machine supervised by a human). The advertiser user 132 may be associated with the advertiser device 130 and may be a user of the advertiser device 130. For example, the advertiser device 130 may be a desktop computer, a vehicle computer, a tablet computer, a navigational device, a portable media device, a smartphone, or a wearable device (e.g., a smart watch or smart glasses) belonging to the first user 132. Likewise, the website user 142 may be associated with the user device 140, and the publisher user 152 may be associated with the publisher device 150. The advertiser user 132 may desire to place advertisements for e-marketing in various websites of various publishers that are likely to generate web traffic to associated advertiser websites. The user 142 may be an entity that accesses content on a publisher user 152 website, who may be a target audience of the advertiser user 132. The publisher user 152 may be an entity who generates one or more websites that provide content for users 142, and who may generate revenue by allowing advertisers to pay for placing their advertisements on the publisher website(s). As previously discussed, the network-based system 105 may be operated by a third-party advertising company that helps facilitate the ad placement of the advertiser users 132 onto publisher websites.

In some embodiments, the devices 130, 140, and 150 may be configured to display user interfaces that are coupled to the network 120. For example, the advertiser device 130 may be configured to display and operate an advertiser user interface (UI) 134, the user device 140 may be configured to display and operate an affiliate UI 144, and the publisher device 150 may be configured to display and operate an admin UI 154. The UIs 134, 144, and 154 may be configured to receive inputs from a user, such as users 132, 142, and 152, respectively.

Any of the machines, databases 115, advertiser device 130, user device 140 or publisher device 150 shown in FIG. 1 may be implemented in a general-purpose computer modified (e.g., configured or programmed) by software (e.g., one or more software modules) to be a special-purpose computer to perform one or more of the functions described herein for that machine, database 115, or devices 130, 140, and 150. For example, a computer system able to implement any one or more of the methodologies described herein is discussed below with respect to FIG. 13. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 120 may be any network that enables communication between or among machines, databases 115, and devices (e.g., the server machine 110 and the devices 130, 140, and 150). Accordingly, the network 120 may be a wired network, a wireless network (e.g., a mobile or cellular network), or any suitable combination thereof. The network 120 may include one or more portions that constitute a private network, a public network (e.g., the Internet), or any suitable combination thereof. Accordingly, the network 120 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 120 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

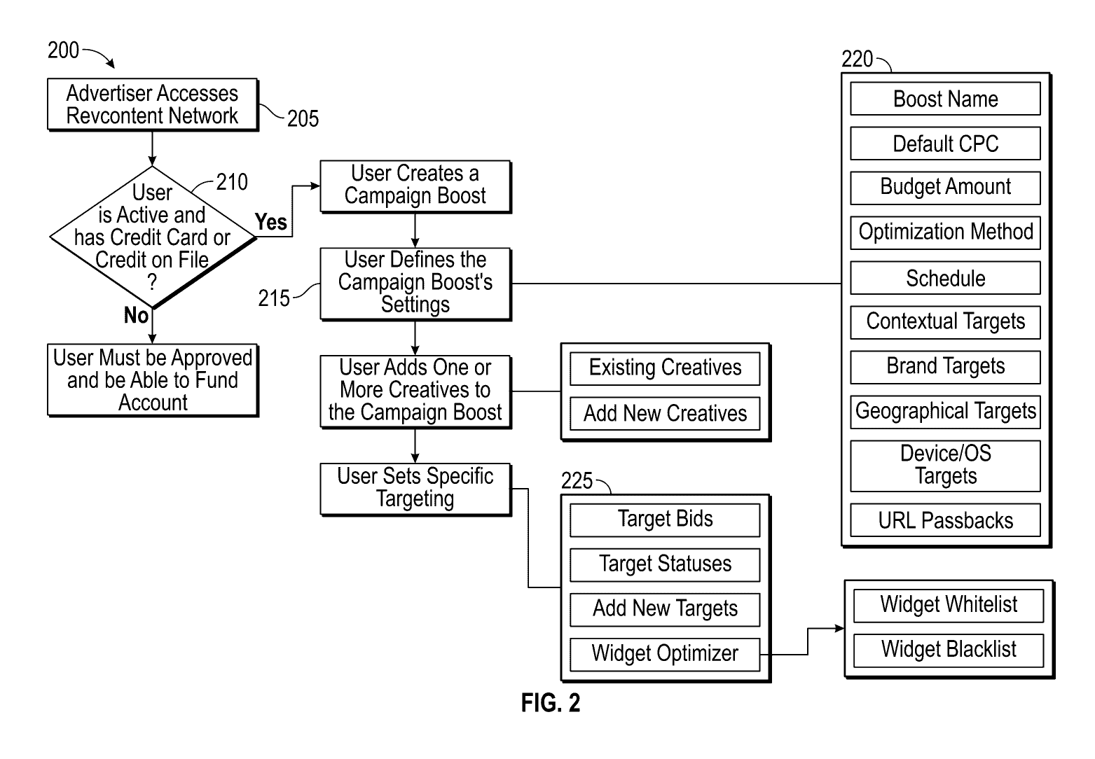

Referring to FIG. 2, illustration 200 provides an example flowchart facilitating advertisement placement on publisher websites through the third party advertising platform, by allowing the advertiser user to create an advertising campaign, according to some embodiments. As previously mentioned, the advertiser may utilize a widget optimizer feature that provides greater control to the advertiser when deciding what websites to place their ads and, in some cases, where in the website the ads are to be placed. In general, third party advertising programs, called widgets, may be embedded into a publisher's website, that contains at least an advertisement and a link directing a viewer to another website associated with the advertiser. The widget optimizer according to aspects of the present disclosures allows the advertiser greater control of where to place these widgets, which may improve ad placement and make the advertising process more effective for each of the publisher, advertiser, and the user. The flowchart in illustration 200 provides an example process for how an advertiser would utilize the third-party advertising platform to place these ads, including accessing the widget optimizer.

The following are example steps that an advertiser user, such as user 132, may perform while accessing the third-party advertising platform, such as through the network-based system 105, according to some embodiments.

First, at step 205, an advertiser may access the third-party advertising network, which is built on the third-party advertising platform. Standard log-in procedures may apply to access the network. Then, at step 210, the platform may determine if the advertiser user is of active status and has credit on file they may create a campaign boost.

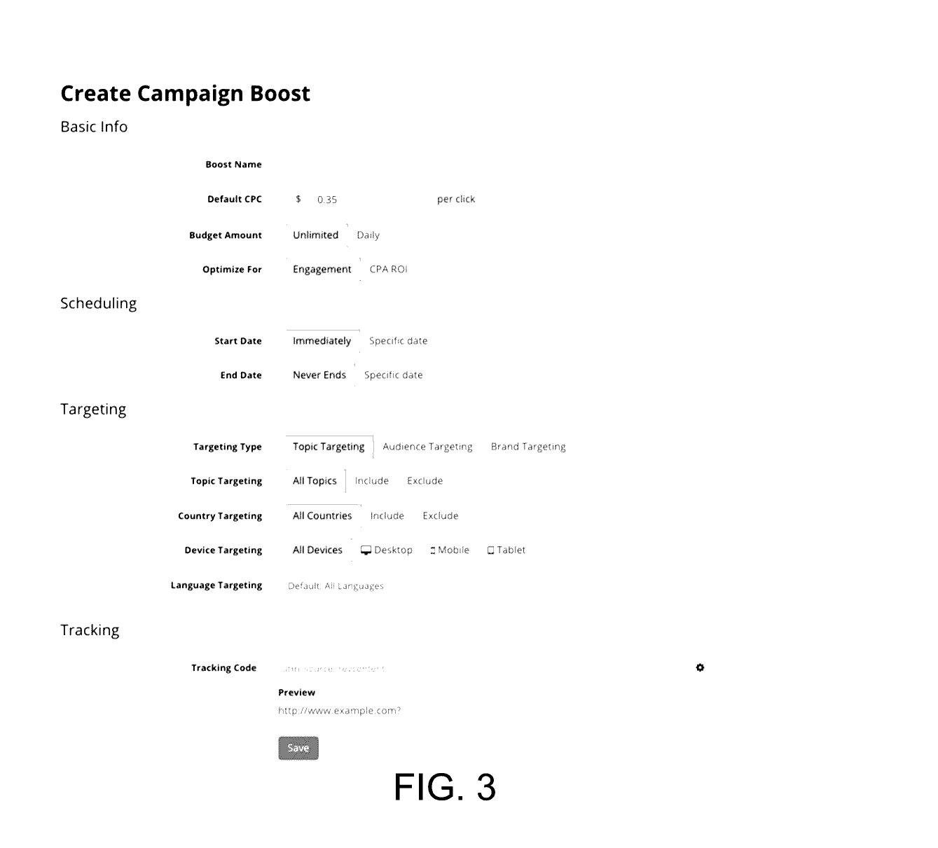

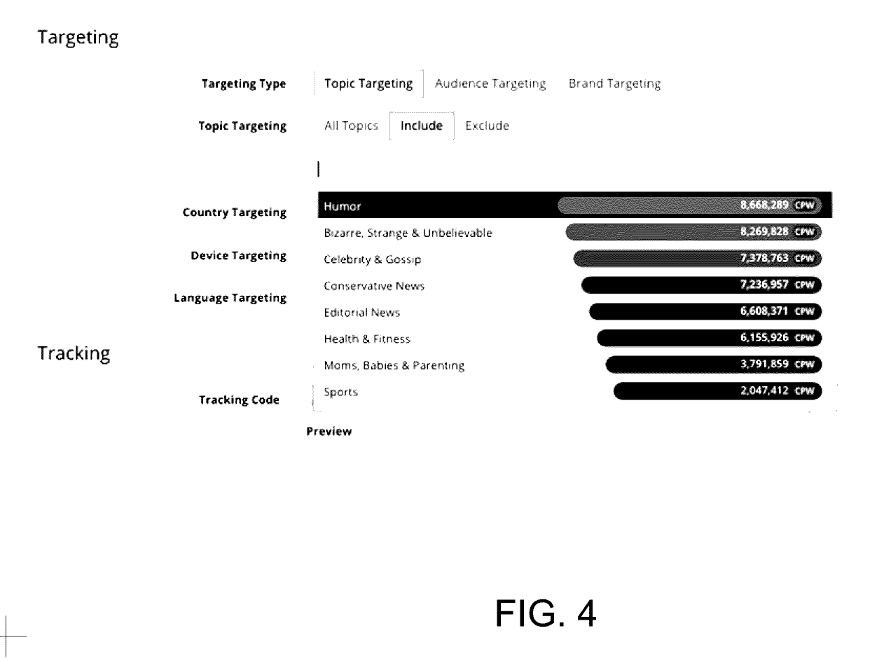

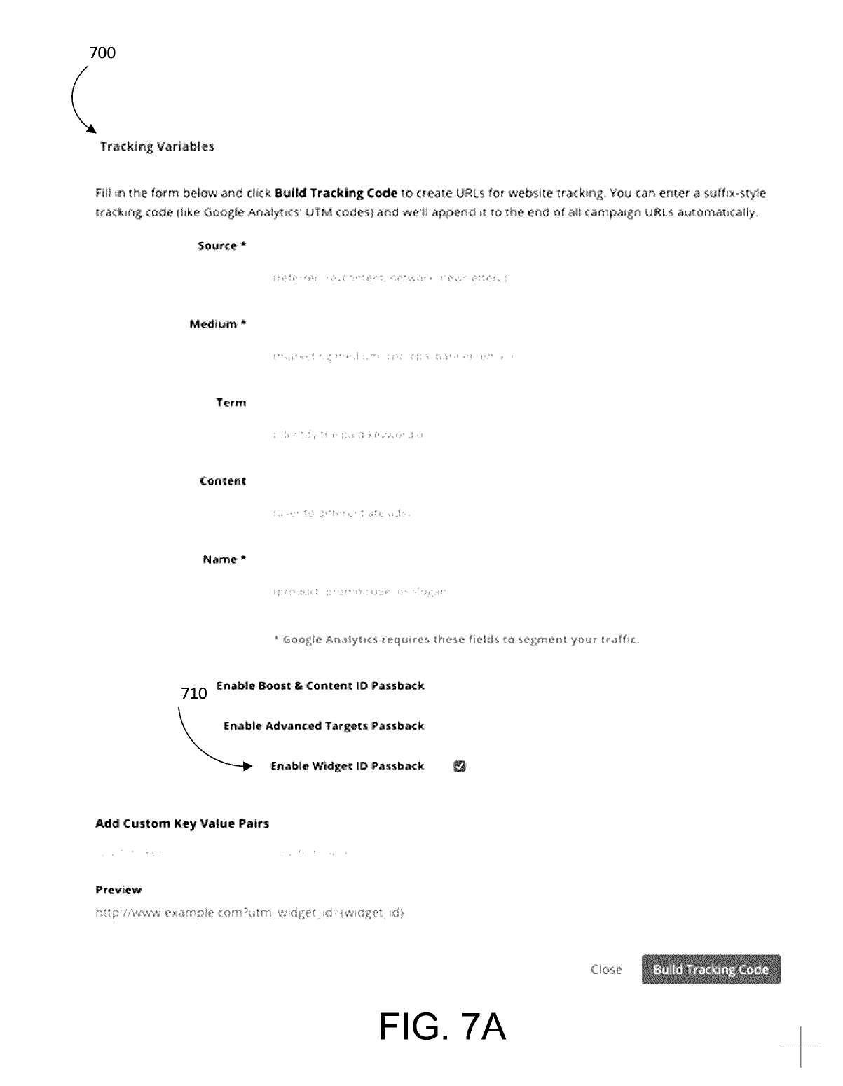

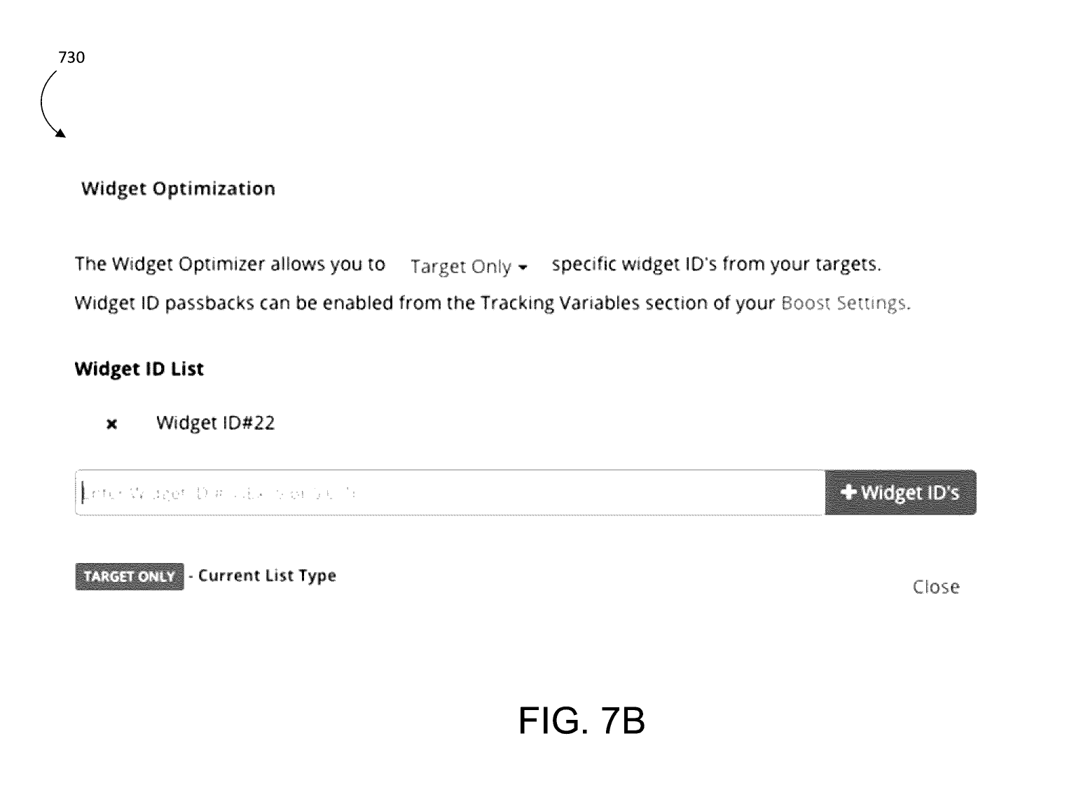

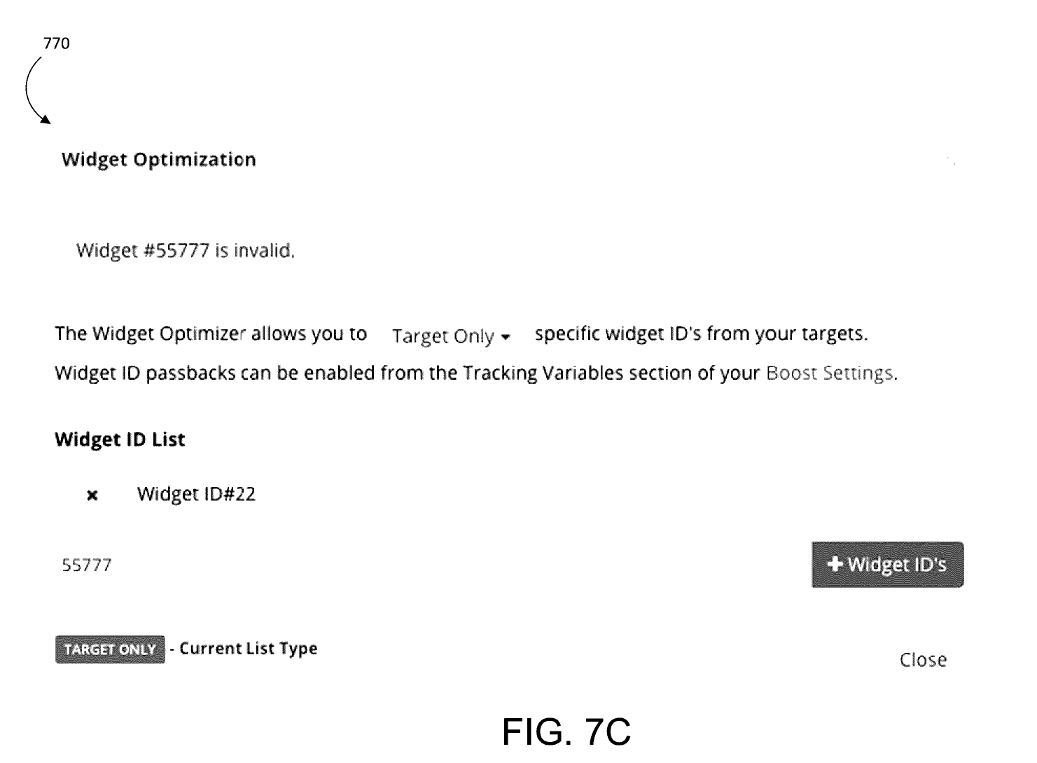

At step 215, after the user has created a campaign and has the option to enable certain features to improve control over the campaign, the user may be prompted to input campaign boost settings, where one option of these settings is URL Passbacks 220. FIGS. 3-6 provide examples of how the advertising platform of the present disclosure may facilitate the creation of a campaign. In some embodiments, URL Passbacks use query string parameters to pass values back to the advertiser from a click event that occurs when a viewer of the publisher website clicks on the advertisement provided in the publisher website. One of these values used for widget optimization is the Widget ID Passback, which is one example of the additional control afforded to the advertiser according to aspects of the present disclosure. FIG. 7A is an example reference that utilizes the Widget ID Passback functionality.

With Widget ID Passback enabled the advertiser is able to then analyze his data, segmenting clicks by widget ID to correlate value to widgets with more clicks for a specific time range.

At step 225, with this information, the advertiser user can then use the widget optimizer interface to blacklist or whitelist various publisher websites. This functionality is purposed to get the advertiser only traffic from converting widgets and block ones that do not convert. FIG. 7B is an example reference that utilizes the whitelist and blacklist functionality.

In some embodiments, when adding widget ID's to a blacklist or whitelist, the widgets are validated against the list of contextual and brand targets that belong to the user, such that the user cannot whitelist or blacklist a widget ID that belongs to a target that they are not actively targeting or have targeted in the past and have now paused targeting for the context and/or brand. FIG. 7C is an example interface that ensures the whitelist or blacklist functionality is applicable only to websites not being actively targeted or have been targeted in the past and now have paused targeting.

In some embodiments, an example process flow for an advertiser user to conduct an advertising campaign as outlined in FIG. 2 may be expressed as follows:

```
{
User enters Advertiser system
If user is not active or does not have a credit card on file
  Print User must be approved and able to fund account
  exit
endif
User creates a Campaign Boost
User defines the campaign boost settings:
    boost name, default cpc, budget amount, optimization method,
    schedule, contextual targets, brand targets, geographical targets,
device/OS targets, url passbacks
User adds one or more creatives to the campaign boost: add new creative,
select existing creatives
User sets specific targeting: Target bids, target statuses, add new targets,
widget optimizer
Widget optimizer allows to whitelist or blacklist specific widgets
}
```

FIGS. 3-6 provide illustrations of example interfaces provided by an advertising platform for facilitating the creation of advertising campaigns, according to some embodiments. These interfaces allow a user to specify a first level of targeted advertising, after which the widget optimizer of the present disclosure may be utilized to allow for a second level of targeting specificity that is believed to be novel in the third party digital advertising industry.

In FIG. 3, a user, such as user 132, may be prompted by the advertising platform to create a campaign boost, according to some embodiments. This may be consistent with the flowchart in FIG. 2, such as specifying the campaign boost settings at step 215. As shown, the user 132 may specify a varied amount of targeting for where to have advertisements placed, including what targeting type (e.g., topic targeting, audience targeting, or brand targeting), topic targeting (e.g., all topics, including or excluding particular topics), country or other location targeting, and device targeting. The option to include or exclude specific criteria in this first level of targeting specificity is illustrative of a first level of whitelisting and blacklisting functionality.

FIG. 4 shows an example of whitelisting at the topic targeting level for a campaign, according to some embodiments. Here, after making a selection to include certain topics, the user 132 may be shown a variety of topics and certain information to help inform decision making. For example, a variety of topics may be shown that are ordered by clicks per week (CPW), providing suggestions for which topics may generate more traffic. The advertising platform may allow for multiple topics to be included in this way, and similar options may be provided for excluding particular topics or other targeting criteria.

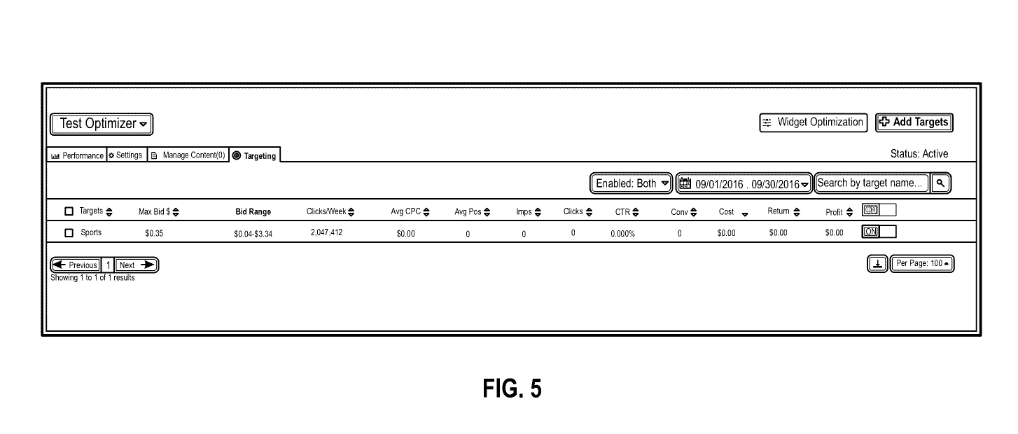

FIG. 5 shows a resulting status screen for any and all criteria that have been specifically targeted from the initial targeting menu shown in FIG. 3, according to some embodiments. Here, an example listing of the topic of sports has been selected to be targeted in the advertising campaign. Various statistics are displayed by the advertising platform to provide information to the user 132 on how successful, at a more general level, the particular topic is for this campaign. In general, other listings showing additional topics or other criteria may be displayed here, to allow the user views of a first level of targeting specificity.

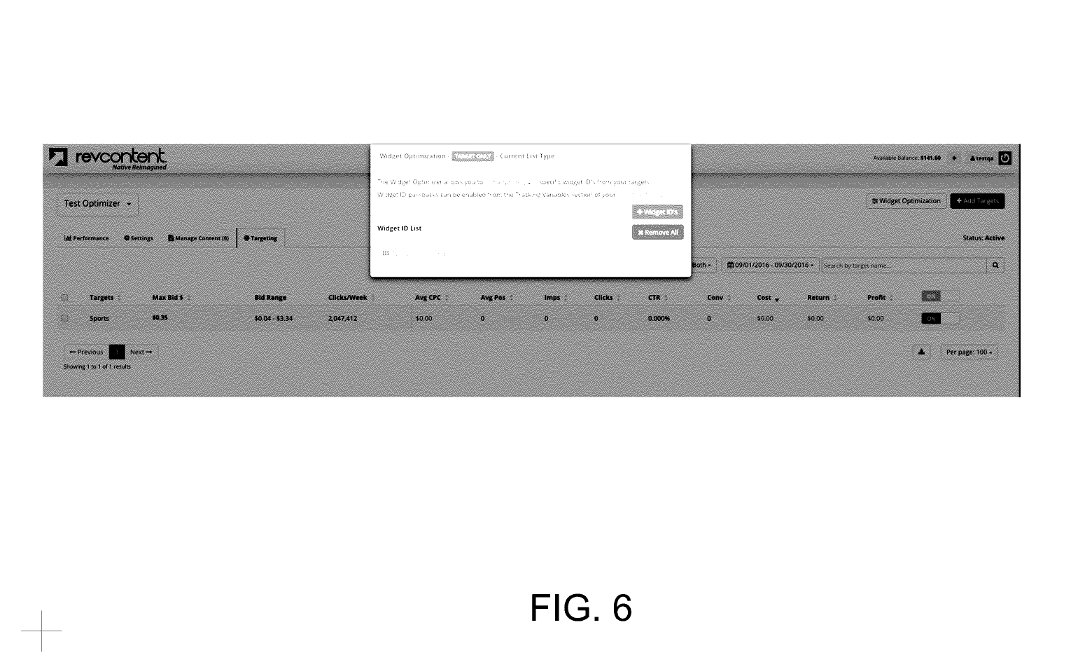

FIG. 6 shows an example display of how the widget optimizer of the present disclosure may be reached and utilized within the campaign creation functionality, according to some embodiments. In this example, after specifying the first level of targeting via whitelisting and/or blacklisting of certain criteria, the advertising platform may allow for the widget optimizer to be utilized to specify a second, more granular level of targeting within the first level of specified targeting. Here, as the sports topic was selected to be targeted in the campaign, the user 132 may now select specific placements of advertisements in specific websites or publishers within the sports topic to be whitelisted or blacklisted using the widget optimizer. That is, a second level of targeting specificity is achievable that whitelists or blacklists particular advertising space within the first level of targeting specificity. In general, the widget optimizer of the present disclosure allows for a second level of targeting within any and all first levels of targeting that is more granular, creating a multi-tiered targeting campaign that allows advertisers to have more control and more effective advertising campaigns.

The technical components of the widget optimizer according to some embodiments includes three sections: the URL passback, the user interface for storing whitelist and blacklists, and the processing to filter out widgets based on the whitelist and blacklist. In other cases, additional widget optimizer functionality is available that further improves the advertiser's experiences and control when conducting an advertising campaign.

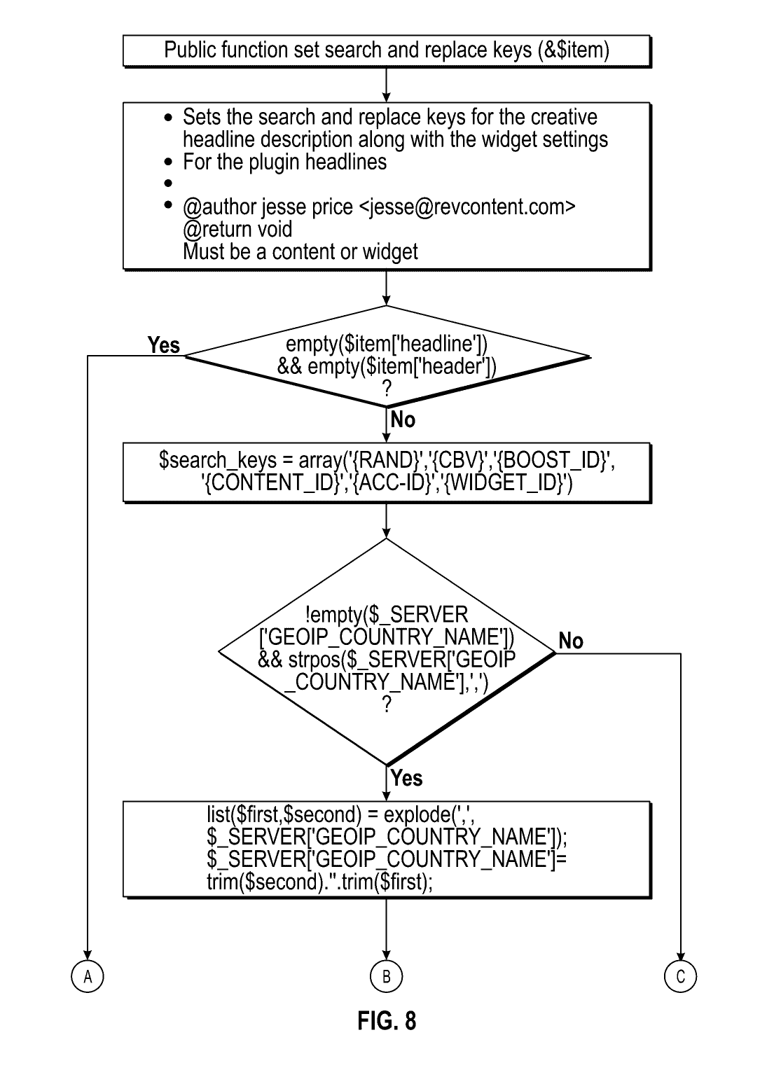

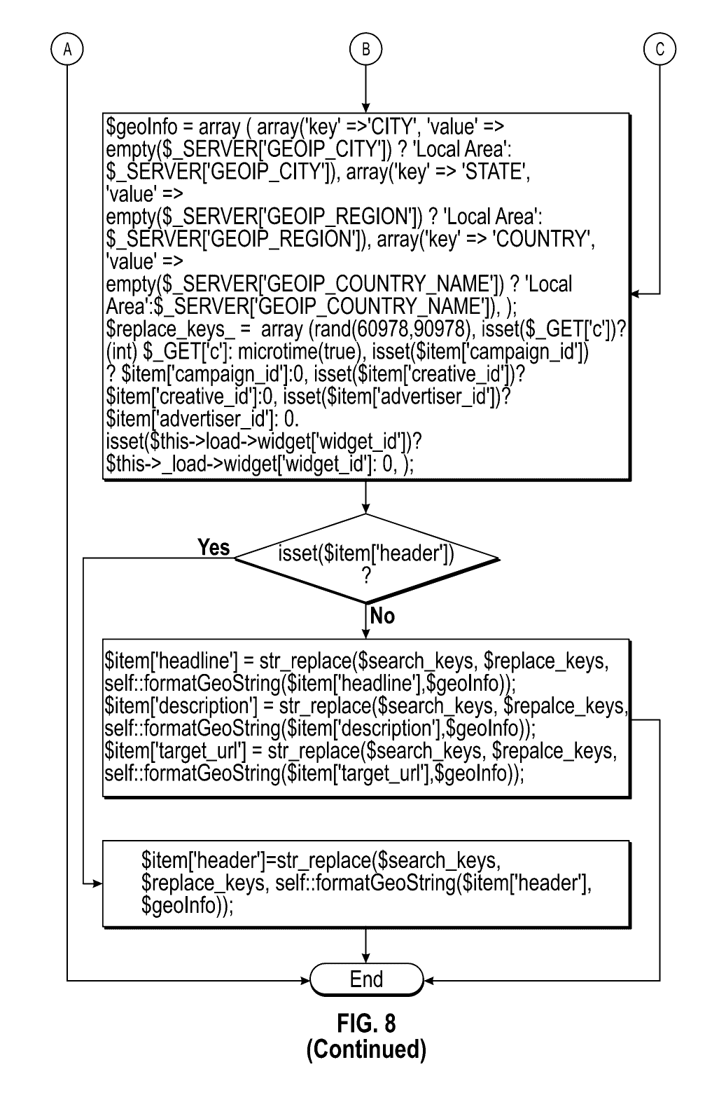

Referring to FIG. 7A, illustration 700 shows an example display interface for utilizing the widget ID URL Passback functionality, according to some embodiments. Here, the advertiser user may enable a switch at checkbox 710 to turn on Widget ID Passback functionality. This functionality allows for populating passbacks from click events. For example, a destination URL is constructed with macro replacements. The entry point to this being enabled for the user is setting widget ID passbacks as referenced in step 215 of FIG. 2, for example. This setting is the indicator to do passback replacement on the URL that is used at the time of a delivery event. Example code for enabling this feature may be referenced in FIG. 8. For example, public function setSearchAndReplaceKeys, which takes from an array of values search_keys, iterates over the destination URLs of the content items to do the macro replacements.

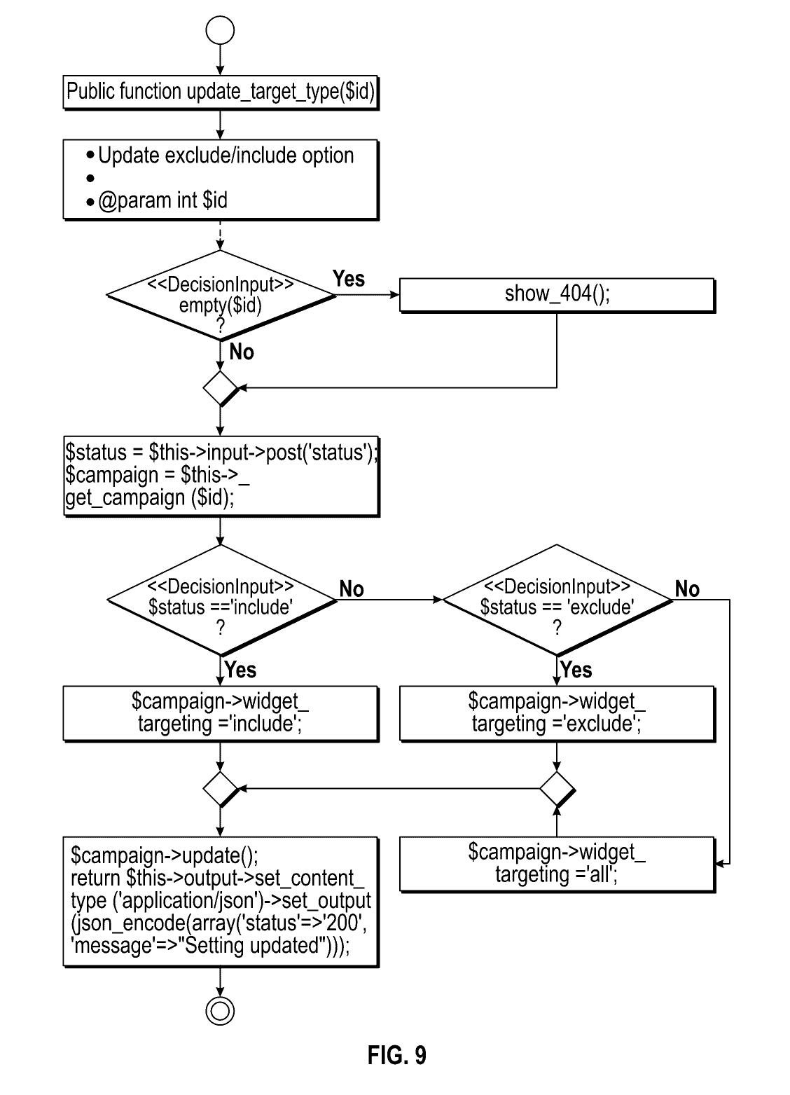

Referring to FIG. 7B, illustration 730 shows an example display interface for utilizing the widget optimizer whitelist and blacklist functionality, according to some embodiments. Here, an example user interface for the widget optimization is displayed, and is driven by a model view controller design pattern. FIG. 9 provides example code execution for the public function update_target_type in the campaign controller for the update operations upon the advertiser user's selection of widget optimization type. The user interface displays the options of “include” or “exclude” with the “include” option being the default.

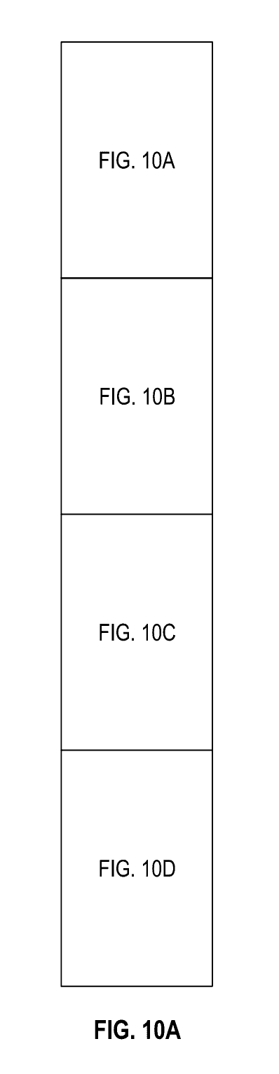

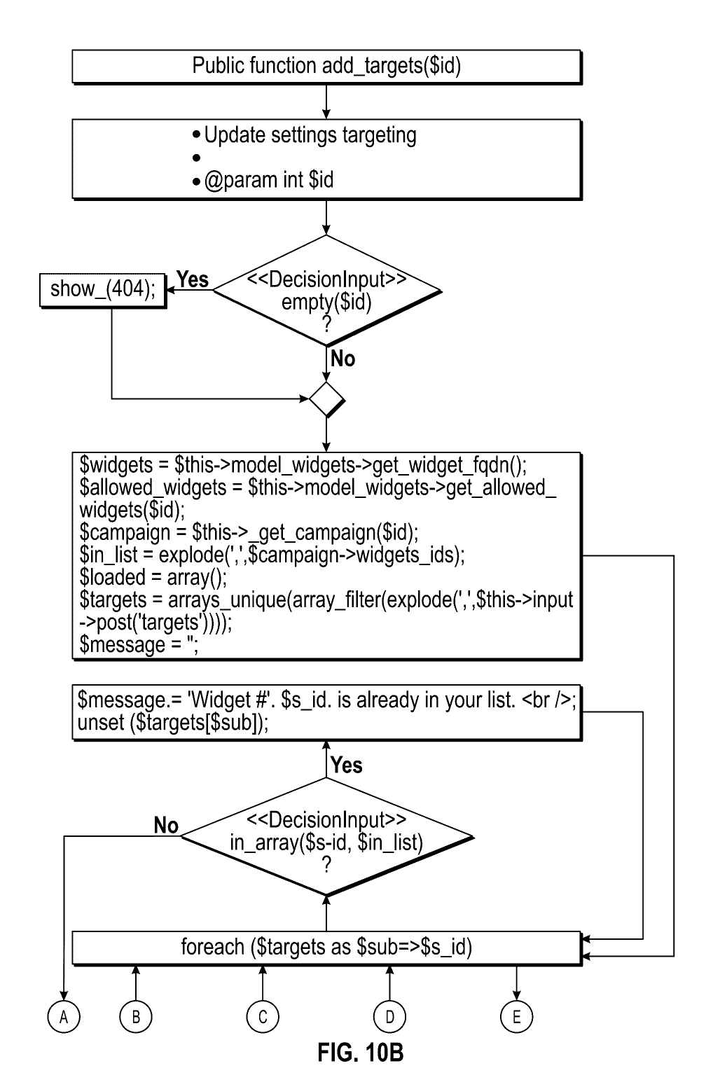

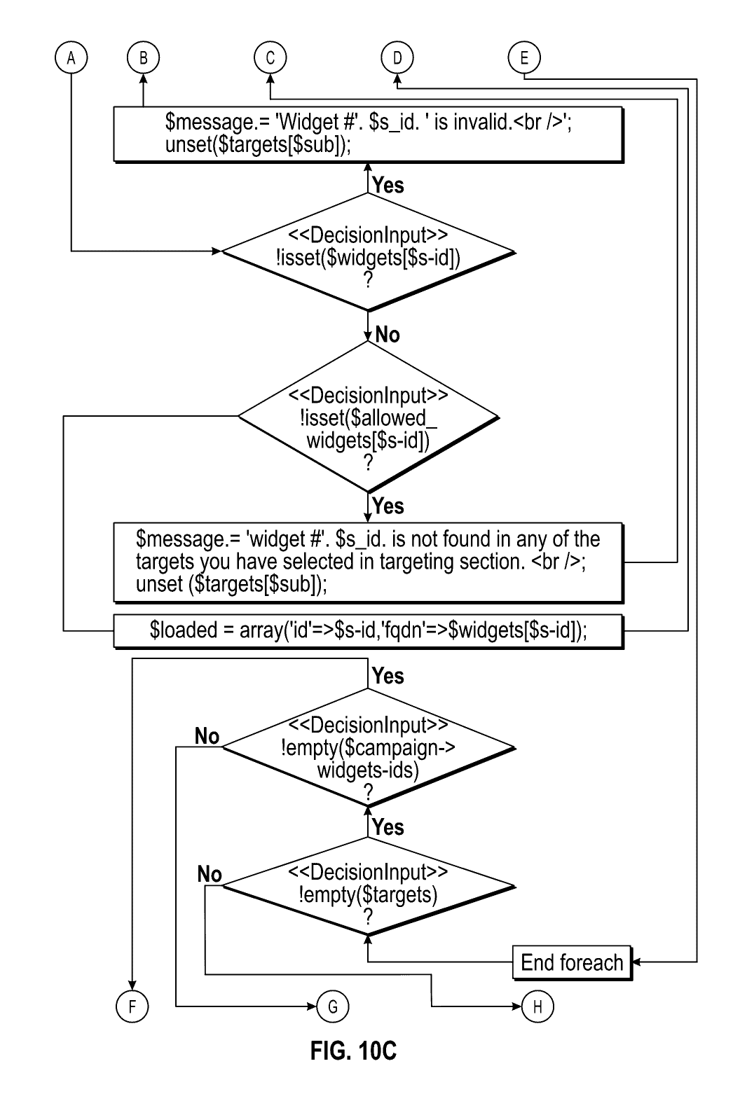

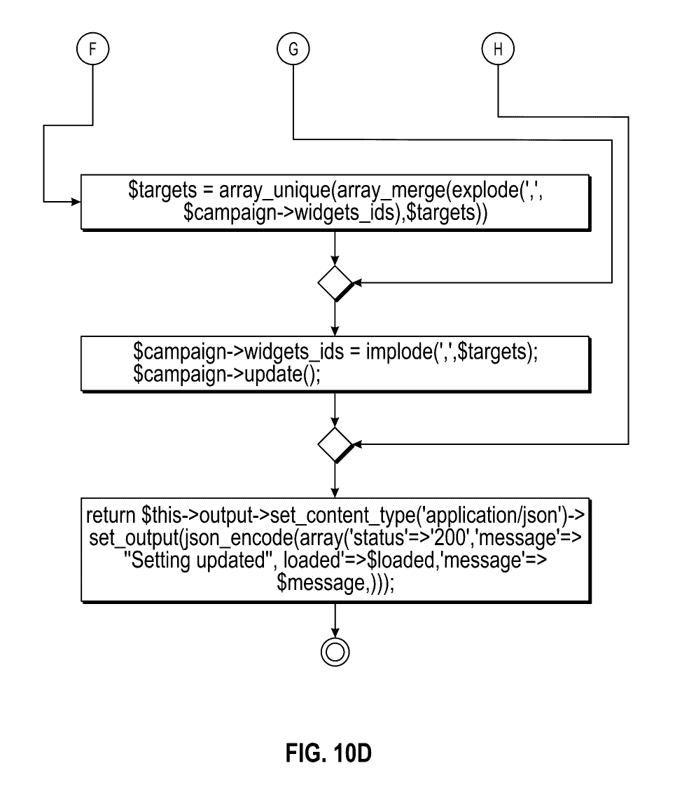

Tied to the whitelist functionality, FIG. 10 shows an example code execution for the public function add_targets in the campaign controller responsible for adding widget ID's to the advertiser user's stored list. This list is independent of the target list type, which is set to either include or exclude. Before a widget ID is stored in the advertiser user's list, there may be three validation checks to be completed, according to some embodiments. The first is if the widget in question already exists in the advertiser user's list. The second is if the widget ID in fact exists in the network, and the third is if the widget ID belongs to one of the targets the advertiser user has selected. These steps are consistent with the step 225 of FIG. 2 and FIG. 7B.

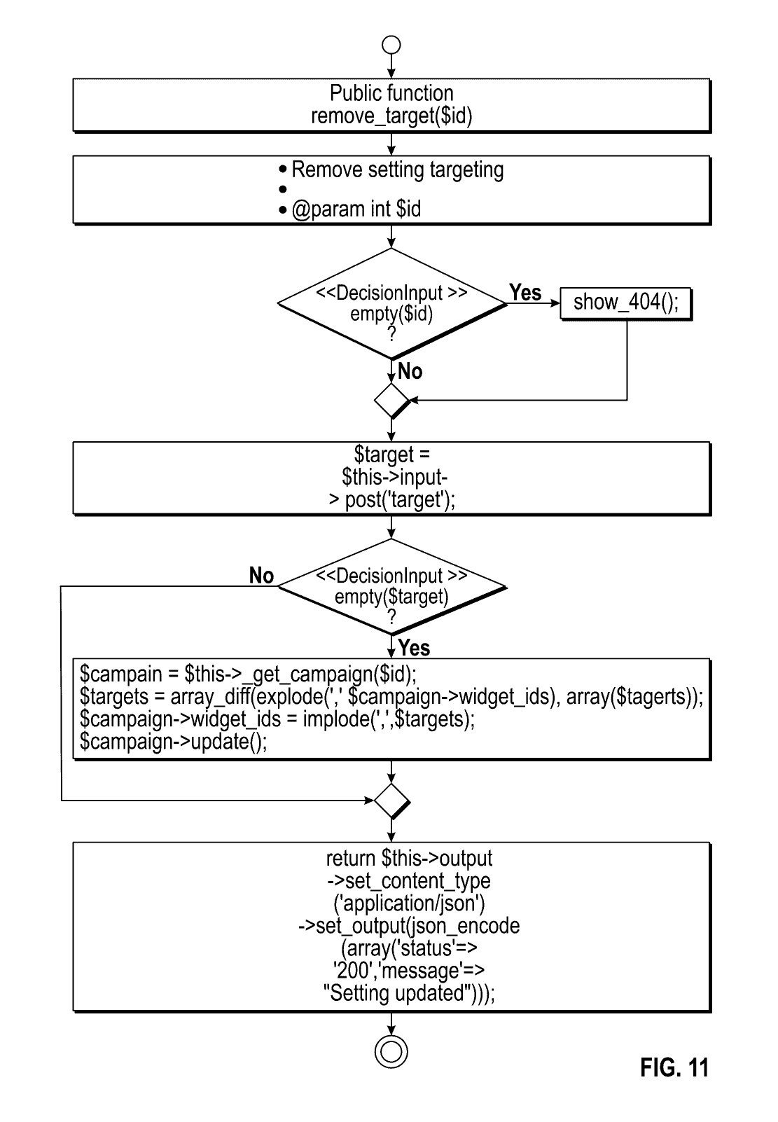

Regarding the blacklist functionality, FIG. 11 shows an example code execution for the public function remove_target in the campaign controller responsible deleting widget ID's from the user specified list.

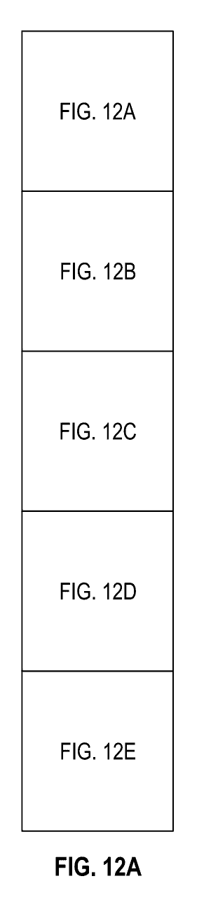

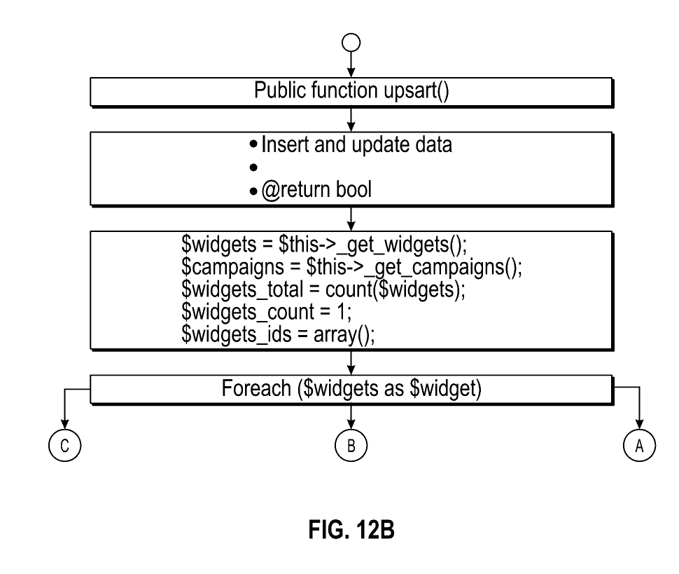

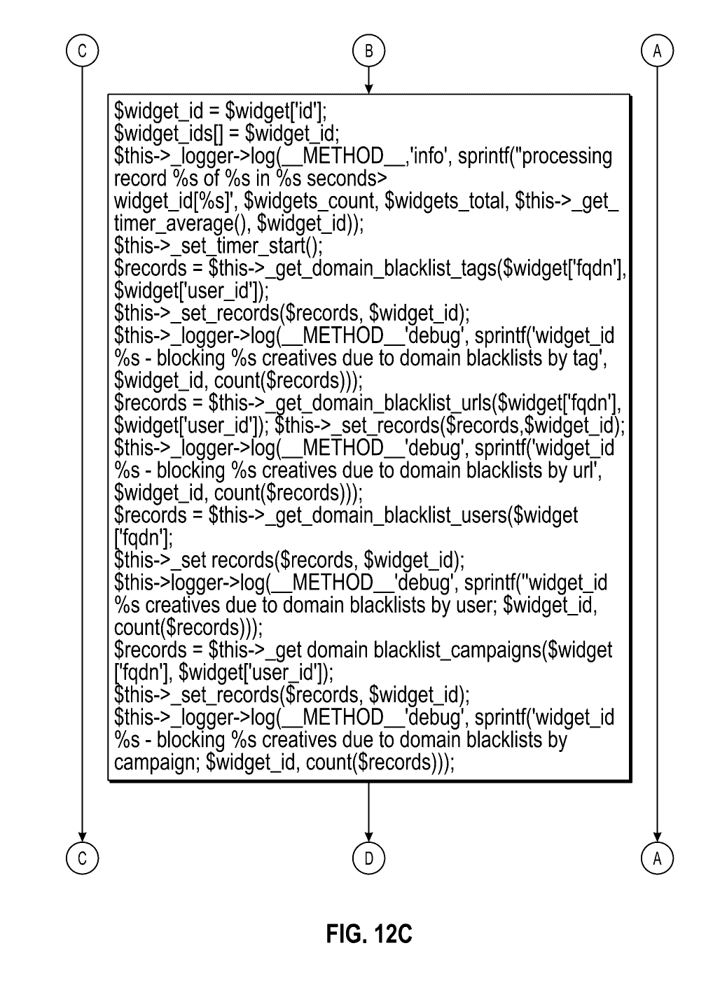

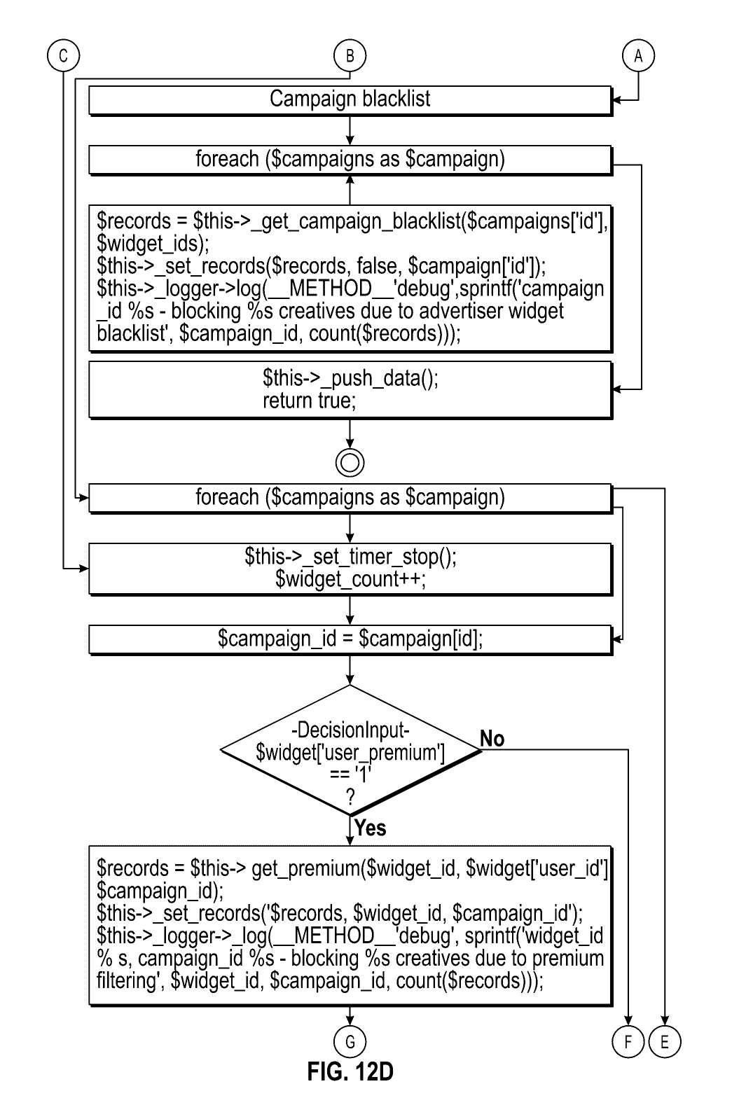

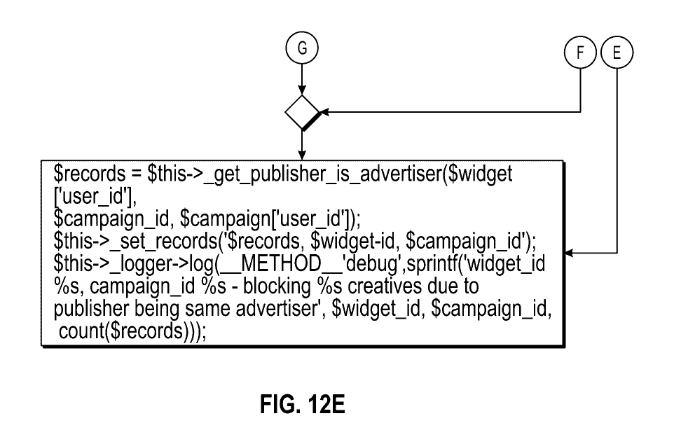

Referring to FIG. 7C, illustration 770 shows an example user interface for processing the whitelist or blacklisted widget IDs, according to some embodiments. For example, based on the user lists stored from the related descriptions of FIG. 7B, the widget optimizer may be able to filter out the advertiser user's campaign when preparing delivery match payloads from actual ad delivery. This processing is handled in the background by the filter process, wherein an example of the code execution for actual filtering process is detailed in the public upsert function featured in FIG. 12.

For reference, in some embodiments, the following pseudocode provides example description for the process flow of the example code provided in FIG. 8 for enabling the passback functionality:

```
Foreach CONTENT
  Call setSearchAndReplaceKeys (&item) {
    If item[Headline] is empty and item[Header] is empty
      skip
    endif
    Set Search Keys = (RAND, CBV, BOOST_ID, CONTENT_ID,
ACC_ID, WIDGET_ID)
    If GEOIP Country Name contains a commo
      Split the GEOIP Country Name by the comma into two parts
      Reverse those parts and concat them back into the GEOIP Country
Name with a space
    endif
    Set Geo Info {
      Set Key = CITY, Value = empty(GEOIP City Name) ? Local Area:
GEOIP City Name
      Set Key = STATE, Value = empty(GEOIP State Name) ? Local
Area: GEOIP State Name
      Set Key = COUNTRY, Value = empty(GEOIP Country Name) ?
Local Area: GEOIP Country Name
    }
    Set Replace Keys {
      Set 0 = rand(60978, 90978)
      Set 1 = isset(GET[‘c’]) ? (int) GET[‘c’] : microtime(true)
      Set 2 = isset(Campaign Id) ? Campaign Id : 0
      Set 3 = isset(Creative Id) ? Creative Id : 0
      Set 4 = isset(Advertiser Id) ? Advertiser Id : 0
      Set 5 = isset(Widget Id) ? Widget Id: 0
    }
    If item[Header] is set
      item[Header] = formatGeoString(item[Header], Geo Info)
      item[Header] = string replace Search Keys with Replace Keys
    endif
    item[Headline] = formatGeoString(item[Headline], Geo Info)
    item[Headline] = string replace Search Keys with Replace Keys
    item[Description] = formatGeoString(item[Description], Geo Info)
    item[Description] = string replace Search Keys with Replace Keys
    item[Target Url] = formatGeoString(item[Target Url], Geo Info)
    item[Target Url] = string replace Search Keys with Replace Keys
  }
endforeach
formatGeoString (String GeoInfo) {
  If GeoInfo[0][Value] == Local Area AND GeoInfo[1][Value] ==
  Local Area
    If String matches expression /{CITY}\s*,\s*{STATE}\s*,\s*
    {COUNTRY}/i
      Set String = Regular Expression Replace
/{CITY}\s*, \s*{STATE}\s*, \s*{COUNTRY}/i
        with GeoInfo[2][Value]
    else if String matches expression /{CITY}\s*[,|:]?\s*{STATE}/i
      Set String = Regular Expression Replace /{CITY}\s*[,|:]?\s*
{STATE}/i with GeoInfo[0][Value]
    endif
  else if GeoInfo[0][Value] == Local Area
    Set String = Regular Expression Replace /{CITY}\s*[,|:]?\s*
{STATE}/i with GeoInfo[1][Value]
  else if GeoInfo[1][Value] == Local Area
    Set String = Regular Expression Replace /{CITY}\s*[,|:]?\s*
{STATE}/i with GeoInfo[0][Value]
  endif
  For Y = 0, Y < count(GeoInfo); Y++
    Set String = Case insensitive replace GeoInfo[Y][Key] with
respective GeoInfo[Y][Value]
  endforloop
}
```

For reference, in some embodiments, the following pseudocode provides example description for the process flow of the example code provided in FIG. 9 for incorporating the whitelisted or blacklisted websites into an advertising campaign:

```
Update_Target_Type (Campaign Id) {
  If Campaign Id is empty
    Redirect 404 Error
  endif
  Set Status = POST[status]
  Set Campaign = Get Campaign Info Model (Campaign Id)
  If Status == include
    Set Campaign->widget_targeting = include
  else if Status == exclude
    Set Campaign->widget_targeting = exclude
  else
    Set Campaign->widget_targeting = all
  endif
  Update Campaign
  Output application/json Content-Type header
  Output json encoded array {
    status = 200
    message = Setting updated
  }
}
```

For reference, in some embodiments, the following pseudocode provides example description for the process flow of the example code provided in FIG. 10 for adding whitelisted websites to an advertiser's list:

```
Add_Targets (Campaign Id) {
  If Campaign Id is empty
    Redirect 404 Error
  endif
  Set InList = Get Existing Widget Id List For Campaign Id
  Set Widgets = Get List of Widgets along with their Fully Qualified
Domain Names (FQDN)
  Set Campaign = Get Campaign Info Model (Campaign Id)
  Set Allowed Widgets = (Campaign->domain_tag_targeting == all)
          ? { } : Get List of Widgets Allowed To be Targeted
  Set Targets = Get Unique Items, Filtering empty variables from POST
  [targets]
  Set Message = ‘’
  Set Loaded = [ ]
  Foreach Targets as Target
    If Target In InList
      Set Message = Message + ‘Widget #Target is already in your list.
      <br />’
      Remove Target from Targets
      Continue
    endif
    If Target in Widgets
      Set Message = Message + ‘WIdget #Target is invalid.<br />’
      Remove Target from Targets
      Continue
    endif
    If Campaign->domain_tag_targeting != all AND Target Not in
    Allowed Widgets
      Set Message = Message + ‘Widget #Target is not found in any of
        the targets ‘ + ‘you have selected in targeting section.<br />’
      Remove Target from Targets
      Continue
    endif
    Set Loaded[ ] = Key => Target, Fqdn => Widgets[Target]
  endforeach
  If Targets is not Empty
    Foreach Targets as Target
      Add Blacklist Target to Campaign List (Campaign Id, Target)
    endforeach
  endif
  Output application/json Content-Type header
  Output json encoded array {
    status = 200
    loaded = Loaded
    message = Message
  }
}
```

For reference, in some embodiments, the following pseudocode provides example description for the process flow of the example code provided in FIG. 11 for removing blacklisted websites from an advertiser user's list:

```
Remove_Target (Campaign Id) {
  If Campaign Id is empty
    Redirect 404 Error
  endif
  Set Target = Get POST[target]
  If Target is Not Empty
    Remove Campaign Target (Campaign Id, Target)
  endif
  Output application/json Content-Type header
  Output json encoded array {
    status = 200
    message = Setting Updated
  }
}
```

For reference, in some embodiments, the following pseudocode provides example description for the process flow of the example code provided in FIG. 12 for applying the whitelisted and blacklisted settings in a filtering process, herein referred to as an upsert function:

```
Upsert {
  Set Widgets = Get list of widgets
  Set Campaigns = Get list of campaigns
  Set WidgetsTotal = Count of Widgets
  Set WidgetsCount = 1
  Foreach Widgets as Widget:
    Widget Id = Widget [Id]
    Set Records = Get Domain Blacklist Tags (Widget[Domain Name],
    Widget[User Id])
    Merge Records (Records, Widget Id)
    Set Records = Get Domain Blacklist Urls(Widget[Domain Name],
    Widget[User Id])
    Merge Records (Records, Widget Id)
    Set Records = Get Domain Blacklist Users (Widget[Domain Name])
    Merge Records (Records, Widget Id)
    Set Records = Get Domain Blacklist Campaigns(Widget[Domain
Name], Widget[User Id])
    Merge Records (Records, Widget Id)
    Set Records = Get Campaign Blacklist(Widget Id)
    Merge Records (Records, Widget Id)
    Foreach Campaigns as Campaign:
      Set Campaign Id = Campaign[Id]
      If Widget[User Premium] == 1
        Set Records = Get Premium (Widget Id, Widget[User Id],
        Campaign Id)
        Merge Records (Records, Widget Id, Campaign Id)
      endif
      Set Records = Get Publisher Is Advertiser (Widget[User Id],
Campaign Id, Campaign[User Id])
      Merge Records (Records, Widget Id, Campaign Id)
    endforeach
    Set Widgets Count = Widgets Count + 1
  endforeach
  Flush Old Data( )
}
```

Referring to FIG. 13, the block diagram illustrates components of a machine 1300, according to some example embodiments, able to read instructions 1324 from a machine-readable medium 1322 (e.g., a non-transitory machine-readable medium, a machine-readable storage medium, a computer-readable storage medium, or any suitable combination thereof) and perform any one or more of the methodologies discussed herein, in whole or in part. Specifically, FIG. 13 shows the machine 1300 in the example form of a computer system (e.g., a computer) within which the instructions 1324 (e.g., software, a program, an application, an applet, an app, or other executable code) for causing the machine 1300 to perform any one or more of the methodologies discussed herein may be executed, in whole or in part.

In alternative embodiments, the machine 1300 operates as a standalone device or may be connected (e.g., networked) to other machines. In a networked deployment, the machine 1300 may operate in the capacity of a server machine 110 or a client machine in a server-client network environment, or as a peer machine in a distributed (e.g., peer-to-peer) network environment. The machine 1300 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1324, sequentially or otherwise, that specify actions to be taken by that machine. Further, while only a single machine 1300 is illustrated, the term “machine” shall also be taken to include any collection of machines that individually or jointly execute the instructions 1324 to perform all or part of any one or more of the methodologies discussed herein.

The machine 1300 includes a processor 1302 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1304, and a static memory 1306, which are configured to communicate with each other via a bus 1308. The processor 1302 may contain microcircuits that are configurable, temporarily or permanently, by some or all of the instructions 1324 such that the processor 1302 is configurable to perform any one or more of the methodologies described herein, in whole or in part. For example, a set of one or more microcircuits of the processor 1302 may be configurable to execute one or more modules (e.g., software modules) described herein.

The machine 1300 may further include a video display 1310 (e.g., a plasma display panel (PDP), a light emitting diode (LED) display, a liquid crystal display (LCD), a projector, a cathode ray tube (CRT), or any other display capable of displaying graphics or video). The machine 1300 may also include an alphanumeric input device 1312 (e.g., a keyboard or keypad), a cursor control device 1314 (e.g., a mouse, a touchpad, a trackball, a joystick, a motion sensor, an eye tracking device, or other pointing instrument), a storage unit 1316, a signal generation device 1318 (e.g., a sound card, an amplifier, a speaker, a headphone jack, or any suitable combination thereof), and a network interface device 1320.

The storage unit 1316 includes the machine-readable medium 1322 (e.g., a tangible and non-transitory machine-readable storage medium) on which are stored the instructions 1324 embodying any one or more of the methodologies or functions described herein, including, for example, any of the descriptions of FIGS. 2-8. The instructions 1324 may also reside, completely or at least partially, within the main memory 1304, within the processor 1302 (e.g., within the processor's cache memory), or both, before or during execution thereof by the machine 1300. The instructions 1324 may also reside in the static memory 1306.

Accordingly, the main memory 1304 and the processor 1302 may be considered machine-readable media 1322 (e.g., tangible and non-transitory machine-readable media). The instructions 1324 may be transmitted or received over a network 1326 via the network interface device 1320. For example, the network interface device 1320 may communicate the instructions 1324 using any one or more transfer protocols (e.g., HTTP). The machine 1300 may also represent example means for performing any of the functions described herein, including the processes described in FIGS. 2-8.

In some example embodiments, the machine 1300 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 1322 able to store data temporarily or permanently and may be taken to include, but not be limited to, random-access memory (RAM), read-only memory (ROM), buffer memory, flash memory, and cache memory. While the machine-readable medium 1322 is shown in an example embodiment to be a single medium, the term “machine-readable medium” should be taken to include a single medium or multiple media (e.g., a centralized or distributed database 115, or associated caches and servers) able to store instructions 1324. The term “machine-readable medium” shall also be taken to include any medium, or combination of multiple media, that is capable of storing the instructions 1324 for execution by the machine 1300, such that the instructions 1324, when executed by one or more processors of the machine 1300 (e.g., processor 1302), cause the machine 1300 to perform any one or more of the methodologies described herein, in whole or in part. Accordingly, a “machine-readable medium” refers to a single storage apparatus or device such as machines 110, 130, 140, or 150, as well as cloud-based storage systems or storage networks that include multiple storage apparatus or devices such as machines 110, 130, 140 or 150. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 1322 is non-transitory in that it does not embody a propagating signal. However, labeling the tangible machine-readable medium 1322 as “non-transitory” should not be construed to mean that the medium is incapable of movement; the medium should be considered as being transportable from one physical location to another. Additionally, since the machine-readable medium 1322 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 1322 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 1302 or a group of processors 1302) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 1302 or other programmable processor 1302. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 1308) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1302 that are temporarily configured (e.g., by software) or permanently configured to perform the relevant operations. Whether temporarily or permanently configured, such processors 1302 may constitute processor-implemented modules that operate to perform one or more operations or functions described herein. As used herein, “processor-implemented module” refers to a hardware module implemented using one or more processors 1302.

Similarly, the methods described herein may be at least partially processor-implemented, a processor 1302 being an example of hardware. For example, at least some of the operations of a method may be performed by one or more processors 1302 or processor-implemented modules. As used herein, “processor-implemented module” refers to a hardware module in which the hardware includes one or more processors 1302. Moreover, the one or more processors 1302 may also operate to support performance of the relevant operations in a “cloud computing” environment or as a “software as a service” (SaaS). For example, at least some of the operations may be performed by a group of computers (as examples of machines 1300 including processors 1302), with these operations being accessible via a network 1326 (e.g., the Internet) and via one or more appropriate interfaces (e.g., an API).

The performance of certain operations may be distributed among the one or more processors 1302, not only residing within a single machine 1300, but deployed across a number of machines 1300. In some example embodiments, the one or more processors 1302 or processor-implemented modules may be located in a single geographic location (e.g., within a home environment, an office environment, or a server farm). In other example embodiments, the one or more processors 1302 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 1300 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A method for conducting advertising in digital media, the method comprising:
receiving, by a processor, an input by an advertiser to generate an e-marketing advertising campaign;
receiving, by the processor, information associated with one or more advertisements to be displayed in one or more publisher's websites;
generating, by the processor, one or more widgets comprising an image associated with an advertisement of the advertiser and a URL associated with a website of the advertiser, the widget configured to be embedded into the one or more publisher's websites and to display the image associated with the advertisement on the one or more publisher's websites;
receiving from the advertiser an input to operate a widget optimizer function that enables the advertiser to directly control at least one characteristic defining how the widget is to be displayed in the one or more publisher's websites; and
causing display of the image of the widget in the one or more publisher's websites in accordance with how the advertiser has defined the widget to be displayed.

2. The method of claim 1, further comprising:
receiving an input to enable a URL passback function to be applied to the widget, the URL passback function configured to track an ID tag associated with the widget.

3. The method of claim 1, wherein the at least one characteristic comprises a location in a publisher's website.

4. The method of claim 1, wherein the at least one characteristic comprises a whitelist enablement feature to require that the widget be displayed in a whitelisted website.

5. The method of claim 1, wherein the at least one characteristic comprises a blacklist feature to require that the widget be prohibited from being displayed in a blacklisted website.

6. The method of claim 5, wherein receiving the input to generate the e-marketing campaign comprises receiving an input to whitelist a category of websites to be targeted in the e-marketing campaign.

7. The method of claim 6, wherein the blacklisted website that the widget is prohibited from being displayed in is a website among the whitelisted category of websites to be targeted in the e-marketing campaign.

8. A system comprising:
a server comprising a memory and a processor coupled to the memory;
the processor configured to:
receive an input by an advertiser to generate an e-marketing advertising campaign;
receive information associated with one or more advertisements to be displayed in one or more publisher's websites;
generate one or more widgets comprising an image associated with an advertisement of the advertiser and a URL associated with a website of the advertiser, the widget configured to be embedded into the one or more publisher's websites and to display the image associated with the advertisement on the one or more publisher's websites;
receive from the advertiser an input to operate a widget optimizer function that enables the advertiser to directly control at least one characteristic defining how the widget is to be displayed in the one or more publisher's websites; and
cause display of the image of the widget in the one or more publisher's websites in accordance with how the advertiser has defined the widget to be displayed.

9. The system of claim 8, wherein the processor is further configured to:
receive an input to enable a URL passback function to be applied to the widget, the URL passback function configured to track an ID tag associated with the widget.

10. The system of claim 8, wherein the at least one characteristic comprises a location in a publisher's website.

11. The system of claim 8, wherein the at least one characteristic comprises a whitelist enablement feature to require that the widget be displayed in a whitelisted website.

12. The system of claim 8, wherein the at least one characteristic comprises a blacklist feature to require that the widget be prohibited from being displayed in a blacklisted website.

13. The system of claim 12, wherein receiving the input to generate the e-marketing campaign comprises receiving an input to whitelist a category of websites to be targeted in the e-marketing campaign.

14. The system of claim 13, wherein the blacklisted website that the widget is prohibited from being displayed in is a website among the whitelisted category of websites to be targeted in the e-marketing campaign.

15. A non transitory computer readable medium comprising instructions that, when interpreted by a processor, cause a machine to perform operations comprising:
receiving an input by an advertiser to generate an e-marketing advertising campaign;
receiving information associated with one or more advertisements to be displayed in one or more publisher's websites;
generating one or more widgets comprising an image associated with an advertisement of the advertiser and a URL associated with a website of the advertiser, the widget configured to be embedded into the one or more publisher's websites and to display the image associated with the advertisement on the one or more publisher's websites;
receiving from the advertiser an input to operate a widget optimizer function that enables the advertiser to directly control at least one characteristic defining how the widget is to be displayed in the one or more publisher's websites; and
causing display of the image of the widget in the one or more publisher's websites in accordance with how the advertiser has defined the widget to be displayed.

16. The computer readable medium of claim 15, wherein the operation further comprise:
receiving an input to enable a URL passback function to be applied to the widget, the URL passback function configured to track an ID tag associated with the widget.

17. The computer readable medium of claim 15, wherein the at least one characteristic comprises a location in a publisher's website.

18. The computer readable medium of claim 15, wherein the at least one characteristic comprises a whitelist enablement feature to require that the widget be displayed in a whitelisted website.

19. The computer readable medium of claim 15, wherein the at least one characteristic comprises a blacklist feature to require that the widget be prohibited from being displayed in a blacklisted website.

20. The computer readable medium of claim 19, wherein receiving the input to generate the e-marketing campaign comprises receiving an input to whitelist a category of websites to be targeted in the e-marketing campaign; and
the blacklisted website that the widget is prohibited from being displayed in is a website among the whitelisted category of websites to be targeted in the e-marketing campaign.
